(19) United States
(12) Patent Application Publication
(10) Pub. No.: US 2010/0021617 A1
(43) Pub. Date: Jan. 28, 2010

(54) EDIBLE OIL REGENERATING APPARATUS AND METHOD

(76) Inventors: Keiichi Kamada, Osaka (JP); Masami Goto, Hyogo (JP); Yoshikazu Kitajima, Osaka (JP); Hoichi Kakuda, Kyoto (JP); Yusuke Kakuda, Kyoto (JP); Takeshi Kamada, Osaka (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/093,728

(22) PCT Filed: Nov. 13, 2006
(86) PCT No.: PCT/JP2006/322534

§ 371 Date: Jul. 22, 2009

(30) Foreign Application Priority Data
Nov. 15, 2005 (JP) 2005-329724

(51) Int. Cl. A23D 9/00

(52) U.S. Cl. 426/601; 210/150

(57) ABSTRACT

An apparatus and a method are disclosed with which deteriorated edible oil is regenerated into fresher oil by lowering its oxidation degree. The apparatus comprises an air processor unit comprising a first air flow path configured to have an inlet and an outlet and allow air to pass between magnets positioned in close vicinity with their opposite magnetic poles facing each other, and a second air flow path connected to the outlet of the first air flow path and provided with a far-infrared ray emitter member therein; a pump for pressure feeding air to the inlet to the first flow path of the air processor unit; a length of tubing which is connected to the outlet of the second air flow path of the air processor unit, and one or more air spewing holes provided at the tip of the length of tubing. And the method of the invention comprises bringing the air from the apparatus into contact with the deteriorated oil to be treated.

### TECHNICAL FIELD

The present invention relates to an apparatus and a method for regenerating edible oil used in cooking foods, in particular to an apparatus and a method for reducing the edible oil and partly restoring its quality which has deteriorated through its use in preparing fried foods.

### BACKGROUND ART

A large amount of edible oil, mostly vegetable oil, is used in various cooking places like those of restaurants, food production and processing factories and ordinary home kitchens in the process of preparing fried foods including Japanese deep-fried foods (Tempra) and other types of fries foods. Edible oil rapidly deteriorates through oxidation when it is used in preparing fried foods, thereby gradually becoming to give off bad odor and losing its flavor. Fried foods prepared using deteriorated edible oil not only have problems with respect to their smell and taste, but also are questionable concerning their potential influence on the health of those who ingest them.

In restaurants, food producing and processing factories and the like, therefore, deteriorated edible oil which has been used in the preparing fried foods is exchanged for fresh one. Thus, used edible oil (referred to as “waste oil” in the specification) is disposed of as a waste material. As it rapidly deteriorates when used in the preparation of fried foods, edible oil has to be exchanged frequently for fresh one, for example, on daily basis, or even several times a day. This is cost-driving for constant purchase of fresh oil is required. In addition, a large amount of waste oil daily produced is usually to be handed over to expert collectors, since it is not permitted to freely discard it, e.g., in such a manner as throwing it into the sewers. This also sometimes drives up costs depending on conditions. Thus, the costs for purchasing fresh edible oil and disposing of waste oil constitute unnegligible portion of the added values of fried foods.

Meanwhile, with respect to disposal of it, as edible oil is liquid, if it is directly buried in the earth, it could flow into groundwater and rivers, thereby causing pollution of the hydrosphere. Therefore, from the viewpoint of preventing environmental pollution, there is a need for the development of a feasible pollution-free method for disposal of waste oil. Thus, if the production of waste oil can be substantially suppressed, it can lessen the burden of the problem relating to the disposal of waste oil.

A means to suppress the production of waste oil is to lower the oxidation degree of edible oil either by preventing its deterioration or by reducing edible oil which has been once deteriorated. For example, it has been proposed to reduce waste oil poured into a perfectly insulated reduction vessel, by application of high voltage (8000 V) to it through a number of electrode wires immersed in it (see Patent Document 1). However, as it uses high-voltage electricity, this method would require purchase and installation of a perfectly insulated reduction vessel as well as a high-voltage power source, both of which are apparatus not generally provided in cooking places. Further, because the method involves handling of very high voltages, a strict safety control is required, and yet would entail risks of electric shock accidents. Therefore, introduction of the method must be difficult not only for ordinary homes or restaurants but also for many of food production and processing factories. An apparatus has been proposed which works during the process of preparing fried foods to prevent oxidation of the edible oil by application of voltages through a negative electrode enclosed in a semiconductor body immersed in the oil (see Patent Document 2). This apparatus is of a structure which will permit no direct electric current to flow and would avoid an electric shock accident. However, as the semiconductor body, to which voltages are continuously applied, contacts the edible oil while heated, it is necessary to validate by close examination whether safety is guaranteed with the apparatus, from the viewpoint of food safety, paying attention to its interaction with various constituents of foodstuff like water and salts which will join the edible oil during the frying process, as well as to possible leaching some constituents our of the semiconductor. Further, this method can only prevent oxidation of the edible oil and cannot reduce and regenerate the edible oil once oxidized. Therefore, it is necessary for this apparatus to be constantly supplied with power all through the frying process, with the electrode immersed in the heated edible oil. This requires, for safety purpose, that the electrode immersed be secured in the oil. Thus, the apparatus is only compatible with such oil vessels as are installed at a low position, substantially fixedly, and not suited to a frying process employing such cooking utensils as deep fryers.

Thus, no apparatus has been known so far with which deteriorated edible oil can be regenerated into fresher oil, i.e., oil with lower oxidation degrees, and which can be used, conveniently and without safety concerns, in ordinary homes, restaurants, and food production or processing factories. There is, therefore, a potential need for such apparatus.

On the other hand, for cleaning air and water, an apparatus is known which is designed to emit activated air (see Patent Document 3). This apparatus is for cleaning the air in a room (e.g., deodorizing tobacco smell) or water (e.g., removing residual chlorine) by releasing, into the air in the room or into water, activated air which is prepared by passing the air through a far-infrared ray emitter material such as seaweed charcoal and then between permanent magnets which are faced with each other. A similar type of air cleaning apparatus whose structure differs only partly from it is known (see Patent Document 4). This device is used to clean air (e.g., deodorizing tobacco smell) by releasing activated air which is prepared by passing the air between magnets faced with each other, and then through a pipe equipped with far-infrared ray emitting nonwoven cloth which is surrounded by a positively charged layer. Further, a similar apparatus is also known which is a system designed to decompose chlorine-containing hazardous substances in water, such as PCB and trichloroethylene (see Patent Document 5). The system is designed to decompose those chlorine-containing hazardous substances by releasing in water containing PCB, tetrachloroethylene or the like, bubbles which is prepared by passing air, at a high speed, through a magnetic field generated between two magnets, then giving the air electrons released from a charged layer to activate (negative ionization), and then passing it through a far-infrared ray layer to convert it into the activated air, and adding to it a solution of metal ions such as magnesium, potassium and sodium ions. There is nothing, however, which suggests a possible relation of any of those apparatus which utilizes activated air to regeneration of deteriorated edible oil.

### [Patent Document 1] Japanese Patent Application Publication 2001-192694

### [Patent Document 2] Japanese Patent Application Publication 2002-69476

### [Patent Document 3] Japanese Patent Application Publication H08-89952

### [Patent Document 4] Japanese Patent Application Publication H10-15052

### [Patent Document 5] Japanese Patent Application Publication 2000-51850

### DISCLOSURE OF INVENTION

### Problem to be Solved by Invention

Against the above background, the objective of the present invention is to provide an apparatus with which deteriorated edible oil can be regenerated into fresher oil by lowering their oxidation degree.

Through studies to address the above problem, the present inventors found that deteriorated edible oil is regenerated, without using any electrode immersed in the oil, into fresher oil with lowered oxidation degree, by pressure feeding, into the deteriorated oil, fine bubbles of air which are processed by certain physical treatments. The present invention was completed through further studies on the basis of this finding.

Thus, the present invention provides what follows.

(1) An edible oil regenerating apparatus comprising:

an air processor unit comprising a first air flow path configured to have an inlet and an outlet and allow air to pass between magnets positioned in close vicinity with their opposite magnetic poles facing each other, and a second air flow path connected to the outlet of the first air flow path and provided with a far-infrared ray emitter member therein,

a pump for pressure feeding air to the inlet to the first flow path of the air processor unit,

a length of tubing which is connected to the outlet of the second air flow path of the air processor unit, and

one or more air spewing holes provided at the tip of the length of tubing.

(2) The edible oil regenerating apparatus according to (1) above, wherein the magnetic flux density between the magnets is not less than 3400 [G].

(3) The edible oil regenerating apparatus according to (1) or (2) above, wherein the ratio of the length along which the air passes through between the magnets to the distance between the magnets faced with each other is not less than 12.

(4) The edible oil regenerating apparatus according to one (1) to (3) above, wherein the distance between the magnets is 2 to 5 mm.

(5) The edible oil regenerating apparatus according to one of (1) to (4) above, wherein the pump pressure feeds the air so that the inequality Bv≧5100 [Gm/sec] holds, wherein B [G] is the magnetic flux density between the magnets, and v [m/sec] is the velocity of the air passing through between the magnets.

(6) The edible oil regenerating apparatus according to one of (1) to (5) above, wherein L and B are selected so that L and B let inequality LB≧200 [Gm] hold, wherein L [m] is the length along which any portion of the air passes through between the magnets.

(7) The edible oil regenerating apparatus according to one of (1) to (6) above, wherein the magnetic flux density between the magnets is not less than 3400 [G] and the pump pressure feeds the air so that velocity v of the air passing through between the magnets is not less than 1.5 [m/sec].

(8) The edible oil regenerating apparatus according to one of (1) to (7) above, wherein the far-infrared ray emitter member is a sheet carrying fine powder of charcoal disposed along the longitudinal direction of the second air flow path.

(9) The edible oil regenerating apparatus according to one of (1) to (8) above, wherein the air passing through the second air flow path flows for at least 0.3 second along the far-infrared ray emitter member.

(10) The edible oil regenerating apparatus according to one of (1) to (9) above, wherein the tubing is made of Teflon™ or silicone resin, and the air spewing holes are one or more small holes provided in a nozzle made of metal or ceramic provided at the tip of the length of tubing.

(11) A method for regenerating edible oil comprising:

passing air through a space between magnets where the magnetic flux density B is not less than 3400 [G] at a velocity v [m/sec] that lets the inequality Bv≧5000 [Gm/sec] hold,

leading the air that has thus passed to a flow path provided with a far-infrared ray emitter member therein and taking out the air therethrough, and

bringing the air into contact with deteriorated edible oil to be treated.

(12) The method for regenerating edible oil according to (11) above, wherein L and the magnetic flux density B [G] between magnets are selected so that L and B let inequality LB≧200 [Gm] hold, wherein L [m] is the length along which any portion of the air passes through between the magnets.

(13) The method for regenerating edible oil according to (11) or (12) above, wherein the magnetic flux density B between the magnets is not less than 3400 [G] and a pump pressure feeds the air so that velocity v [m/sec] of the air passing through between the magnets is not less than 1.5 [m/sec].

(14) The method for regenerating edible oil according to one of (11) to (13) above, wherein the far-infrared ray emitter member is a sheet carrying fine powder of charcoal.

(15) The method for regenerating edible oil according to one of (11) to (14) above, wherein the ratio of the length along which the air passes through between the magnets to the distance between the magnets is not less than 12.

(16) The method for regenerating edible oil according to one of (11) to (15) above, wherein the distance between the magnets is 2 to 5 mm.

### EFFECT OF INVENTION

The apparatus according to the present invention is used in a manner in which the air coming out of the apparatus is introduced in the form of bubbles into, and brought into contact with, the deteriorated edible oil. By using the apparatus and method according to the present invention defined above, edible oil with raised oxidation degrees is reduced into oil with lowered oxidation degrees, and, simultaneously, bad smell that has been caused by its deterioration is eliminated, thereby improving the flavor of fried foods. As no electrode is immersed in the edible oil to be treated, the present invention involves no insulated reduction vessel and therefore is highly safe without any risk of electric shock accident. Further, the present invention greatly extends the life of edible oil being used in preparing fried foods, thereby reducing the frequency of the disposal of it and cut the gross production of waste oil.

### BRIEF DESCRIPTION OF DRAWINGS

FIG. 1 A plan view of the flow path between the magnets, as well as the flow path within which a far-infrared ray emitter member is provided, of the apparatus according to the present invention.

FIG. 2 An end view of the casing on the outlet side enclosing the flow paths illustrated in FIG. 1.

FIG. 3 A side view (a) and an end view (b) of the flow paths defined by the permanent magnets.

FIG. 4 A side view of the apparatus body.

FIG. 5 A front view of the apparatus body.

FIG. 6 An enlarged side view of the nozzle.

FIG. 7 An enlarged end views of the nozzle on the tubing side (a), and on the distal side (b).

FIG. 8 A schematic view illustrating the apparatus being used to regenerate the edible oil.

FIG. 9 A graph showing the effect of the apparatus according to the present invention against the increase of the acid value of the edible oil.

FIG. 10 A side view of the apparatus of Example 2.

FIG. 11 A plan view of the apparatus of Example 2.

FIG. 12 A schematic perspective view of the appearance of the apparatus of Example 2.

### EXPLANATION OF SIGNS

1=flow path inlet, 2=flow path inlet, 3=fist flow path, 4a, 4b=second flow path, 5=flow path outlet, 10=upper row of magnets, 11=lower row of magnets, 15=spacer, 16=spacer, 18=apparatus body, 20=pump, 22=operation panel, 24=ON/OFF switch, 26=cable drawing opening, 30=tubing, 40=nozzle, 42=cylinder body, 43=packing, 44=packing, 45=frame member, 46=frame member, 48=bolt, 50=bolt, 53=oil vessel, 55=edible oil, 58=apparatus body, 60=air processor unit, 65=pump, 67=pipes, 68=distribution tube, 70=intake vent, 72=power cable, 74=AC coupler, 76=pipes, 78=collecting pipes, 80=tubing, 82=nozzle

### BEST MODE FOR CARRYING OUT THE INVENTION

With regard to the edible oil, “oxidation degree” is a concept representing the degree of their deterioration caused by oxidation. While there are several methods for evaluation of degree of oxidation of fat and oil, such as chemical, physical or sensory methods for evaluation, or biological/enzymatic assays, the Ministry of Health, Labor and Welfare adopts such chemical evaluation that is based on the index of peroxide value (POV) or acid value (AV), for vegetable and animal oils, and it is also provided as the official methods by JAPAN Oil Chemists' Society.

In the present application, “edible oil” means oil used in production and/or processing of foods, regardless of whether it is just a single kind of oil or a mixture of some different kinds. Though it includes vegetable oil, which is used in majority of cases as frying oil in preparing fried foods such as Japanese deep-fried foods (Tempra) and other kinds of fried foods, the term is not limited to vegetable oil but also includes animal oil such as lard, and also easily oxidized oil such as fish oil.

In the present invention, “regenerate” with regard to edible oil means to substantially lower the oxidation degree of edible oil which has been raised.

In the present invention, the apparatus may be built to include only one air processor unit, or to include multiple air processor units arranged in parallel to increase its processing capacity where a large volume of edible oil is to be regenerated. Even in the latter case, though multiple pumps may be employed to pressure feed air to the multiple air processor units, only one pressure feeding pump will also suffice as far as it has sufficient output power, and in such a case air is fed to the air processor units through a branched pipe. Where the apparatus is built including multiple air processor units, there is no limitation as to the number of the air processor units employed, and any number of the units may be installed as desired, like 2, 3, 6, or 10 units.

In the present invention, the magnets employed in association with the first flow path of the air processor unit may either be permanent magnets or electromagnet, or a combination of both. A pair of such magnets are fixed with their opposite magnetic poles (north pole and south pole) facing each other and keeping between them a narrow gap, which define the flow path for the air. Therefore, though it is generally preferable to employ flat magnets (i.e., those whose surfaces are flat where their magnetic poles reside), this is not essential, for it is sufficient as far as a narrow gap is defined between the opposite poles of a pair of magnets. The gap width between the magnets may be determined as desired, but in general is preferably about 2 to 5 mm.

Between the pair of magnets thus faced with each other, there is generated a magnetic field with a direction from the north pole to the south pole, perpendicular to the direction of air flow. The magnets employed preferably have such power that will generate a magnetic flux density of not less than 3400 [G] in the gap between the pair of magnets. As the magnetic field lines between opposed magnetic poles positioned in close vicinity are substantially parallel with one another and not diffused, this requirement is generally met if the magnetic flux density on the surface of the magnets is not less than 3400 [G]. There is no upper limit as to the power of the magnets employed in the present invention, and the more powerful is the field of the magnets, the greater is the effect thus obtained. Also, there is no limitation as to the direction in which the pair of magnets are positioned. Therefore, the north and the south poles may be positioned either as facing vertically so that the direction of the magnetic field lines between them may be in vertically downward or upward, or as facing horizontally at the same level so that the magnetic field lines may lie in a horizontal direction. There is no restriction regarding the direction of the flow path, either. Therefore the flow path may be defined either as a horizontal one or a vertical one, in accordance with the orientation of the pair of the magnets.

Using each pair of magnets as a set, the length of the flow path may be extended, as needed, by arranging a multiple sets in series. In such a case, it is preferred that the orientation of the magnetic poles in each of the sets are coordinated with that of others so that the direction of the magnetic field lines within the gap defined in any of the sets are the same with that of any other set. This is because the effective length of the flow path in the magnetic field (i.e., the net distance that the air flowing in the magnetic field passes through the magnetic filed of a predetermined direction) would be offset if the direction of the magnetic field is reversed in some portion of the flow path.

When the magnitude of the magnetic field in the gap between the paired magnets is 3400 [G], the velocity of the air flowing through the magnetic field is preferably not less than 1.5 [m/sec] for the apparatus to be sufficiently effective, and more preferable not less than 2.0 [m/sec]. As the activation effect the air receives from the magnetic field as it flows through the gap between the paired magnets in the present invention is based on the electromagnetic induction on the air moving in the magnetic field, the effect is proportional to the magnitude of the magnetic field as well as the velocity at which the air flows through the magnetic field. Therefore, the power of the magnets and the velocity of the flow may be selected so that the magnitude of the magnetic field B [G] and the velocity v [m/sec] fulfill the relation, Bv≧3400 [G]×1.5 [m/sec]≈5100 [Gm/sec], and preferably not less than 3400 [G]×2.0 [m/sec]≈6800 [Gm/sec].

When the magnitude of the magnetic field in the gap between the paired magnets is 3400 [G], the effective length of the flow path through the magnetic field is preferably not less than about 6 cm, and more preferably 6 to 12 cm. This is because the effect will substantially decrease if the length is made shorter than 6 cm, while the effect reaches its maximum as the length extends up to 12 cm, and extending the length beyond 12 cm would not substantially increase the effect further, thus being meaningless. Extending the length beyond this would do no harm with respect to the effect, though. It should be noted that since the activation of the air flowing through the gap between the paired magnets according to the present invention is proportional to the magnitude of the magnetic field, there is a following relation between the magnetic flux density B [G] and the effective length L [m] required for the flow path through the magnetic field: LB≧3400 [G]×0.06 [m]≈200 [Gm]. Therefore, the effective length of the flow path through the magnetic field, i.e., the length of the magnets or the number of them arranged in series, may be determined in accordance with the magnitude of the magnetic flux density of the magnets employed. Meanwhile, to increase the velocity of the flow will not substantially affect on the lower limit of the effective length L [m], for it will inversely shorten the time that the air takes to pass through the magnetic field.

Though the combination of the distance between the magnets faced with each other and the length along which the air passes through between the magnets may be set as desired, it is preferable to let the air pass through a narrow, long gap. From this point of view, the length along which the air passes through between the magnets is preferably no less than 12 times, in general, the distance between the magnets, and more preferably 25 to 40 times. Though there is no specific upper limit with this regard, being some 40 times will be sufficient.

In the air processor unit, the air spewing from between the paired magnets is then introduced into the second flow path containing a far-infrared ray emitter member. As a far-infrared ray emitter member, any of well-known ceramics or charcoal powder may be employed. A nonlimiting typical example of it is a sheet (e.g., fibrous cloth or unwoven cloth) to which charcoal powder is adhered. Though such a far-infrared ray emitter member may be disposed in the flow path in any manner as desired, it is preferable to avoid unnecessarily increasing the resistance of the flow path. Therefore the far-infrared ray emitter member is preferably disposed along the length of the flow path in such a manner not to occlude the flow path. In addition, it is preferable to determine the rate of the air flow and the inner diameter of the flow path so that the any portion of the air flowing through the flow path flows for at least 0.3 second along the region where the far-infrared ray emitter member is disposed.

The activated air spewing from the flow path in which the far-infrared ray emitter member is contained flows into a length of tubing which is directly or indirectly connected to the outlet of the apparatus. If a single air processor unit is used alone, the tubing may be directly connected to the outlet of the flow path. Where multiple air processor units arranged in parallel are employed, the air spewing from the outlets of those second flow paths may be combined and lead to the length of tubing, via a connecter device as desired such as a branched pipe connected to the outlets. It is, of course, allowed to connect a separate length of tubing to each of the outlets of the multiple second flow paths as desired. The tubing should be made of such a material that stands heat and oil, for some distal part of it is to be immersed in the edible oil used in preparing fried foods. A few preferable examples of such a material is Teflon™ and silicone resin. At the tip of the length of tubing is provided one or more air spewing holes. Preferably, such spewing holes are provided as small holes in a nozzle attached to the length of tubing. The shape of the nozzle may be formed as desired. Considering the need of heat resistance, the nozzle is preferably formed of ceramic or metal (e.g., stainless steal). Though the nozzle may be provided with only one small hall, it is preferable that a large number of holes are provided each having a diameter as small as possible. This is because the presence of a large number of holes could reduce the load on the pump even they are of small diameter, and because the smaller is the diameter of the holes, the finer become the air bubbles spewed from the nozzle, thereby letting the air contact the oil with increased efficiency.

The apparatus according to the present invention is used in such a manner that it bubbles the activated air spewing from it into the edible oil whose oxidation degree has been increased through its use, e.g., in preparing fried foods. Bubbling may be conducted either while the temperature of the oil is still high or after it is cooled. By introducing into 1 [L] of oil, for example, some 110 [L] of activated air from the apparatus according to the present invention, the oxidation degree of the oil is greatly reduced. This corresponds to about 2-hour treatment of 18 [L] of waste oil with the apparatus described in detail in Example 1 below.

### EXAMPLE

The present invention is described in further detail with reference to a typical example. However, it is not intended that the present invention be restricted by the example.

### Example 1

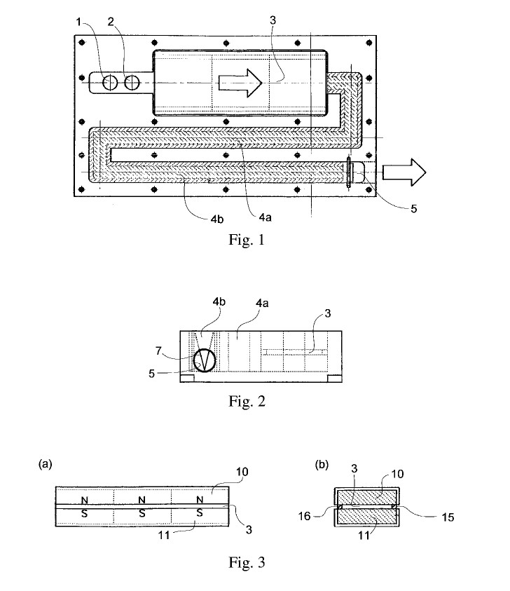

FIG. 1 illustrates a plan view of the flow path between magnets, as well as a flow path within which a far-infrared ray emitter member is disposed, of the apparatus according to the present invention. In the figure, 1 and 2 indicate inlets to the flow path, to both of which pressurized air is fed from a common pump. The inlets 1 and 2 to the flow path are in communication with one end of a first flow path 3 defined by the permanent magnets (the flow path itself is not seen in the figure). Open arrowheads indicate the direction in which the air flows. In the figure, 4a and 4b indicate a second flow path in which a far-infrared ray emitter member is disposed, and 5 indicates the outlet of the flow path. An air processor unit is composed of these first and second flow paths. FIG. 2 illustrates an end view of a casing on the outlet side enclosing those flow paths.

FIGS. 3(a) and 3(b) illustrate a side view and an end view of the flow path 3 defined by the permanent magnets. As seen in FIG. 3(a), the flow path 3 is defined as a gap between an upper magnets row 10 and a lower magnets row 11. As seen in FIG. 3(b), spacers 15, 16 are inserted between the magnets along the both sides of the flow path, and the height of the spacers support the gap width of the flow path 3 (3 mm in this example) and seal the both sides of the flow path. The transverse width of the flow path is 36 mm, the overall length of it 120 mm, and the cross sectional area of the flow path 3 mm×36 mm≈108 mm²=1.08 cm². Either of the upper magnets row 10 or the lower magnets row 11 is composed of 3 permanent magnets arranged in series (40 mm×40 mm×10 mm each), arranged so that the north pole is on the bottom face of the upper magnets row 10 and the south pole on the upper face of the lower magnets row 11. Thus, magnetic flux is formed which has a downward direction within the flow path 3. In the present Example, the magnetic flux density is 3600 [G] for each magnet.

The flow path indicated by 4a and 4b is 23 mm in height and 14 mm in width (cross sectional area: 3.22 cm²), and in each of the potions 4a and 4b of the flow path is inserted as a far-infrared ray emitter member a piece of polyethylene unwoven cloth which is 60 mm wide×180 mm long×about 1 mm thick carrying fine charcoal powder kneaded into it and is folded along its longitudinal central line into a V shape, in the total length of 360 mm in the flow path (schematically illustrated with reference numeral 7 in FIG. 2).

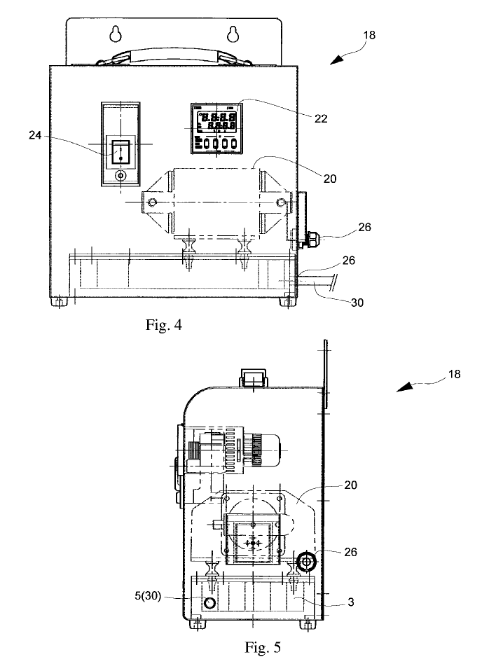

FIG. 4 illustrates a side view of the apparatus body 18. In the figure, the numeral 20 indicates an electromagnetic pump for pressure feeding of the air, which operates on the rated power of 100 V AC, and blow the air at a flow rate of 13.6 L/min where the electric power supply frequency is 50 Hz, and 16.5 L/min where the frequency is 60 Hz. Indicated by 22 is an operation panel for setting a timer, 24 an ON/OFF switch, and 26 a power cable drawing opening. To the outlet 5 of the flow path 4b is connected a length of Teflon™ tubing 30. FIG. 5 illustrates a front view of the apparatus body.

As the cross sectional area of the first flow path is 1.08 cm², if the power supply frequency is 60 Hz, the velocity of the air flowing through the first flow path, is: 16.5×1000/60/1.08 255 cm/sec=2.55 m/sec, and therefore the product of the magnetic flux density B [G] and the velocity v [m/sec] of the air within the first flow path is 9180 [Gm/sec]. Similarly, as the cross sectional area of the second flow path is 3.22 cm², the velocity u [m/sec] of the air within the second flow path is 16.5×1000/60/3.22≈85 cm/sec=0.85 m/sec. As the total length of the far-infrared ray emitter member in the second flow path is 360 mm, any portion of the air flowing through the second flow path flows for the sum of about 0.42 seconds along the far-infrared ray emitter member.

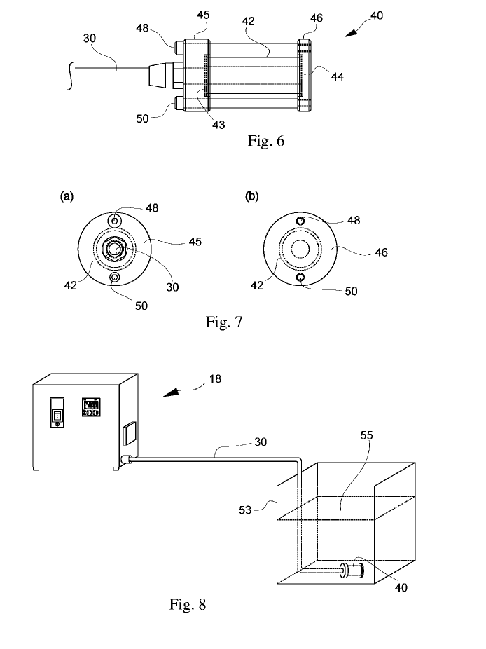

FIG. 6 illustrates an enlarged side view of the nozzle 40 attached at the tip of the length of tubing 30, and FIG. 7 (a) an enlarged end views of the nozzle on the side of the tubing 30 (a) and on the distal end side (b). In FIG. 6, indicated by the numeral 42 is a thick-wall cylindrical body which is made of a ceramic, having a large number of small through pores (air spewing holes) in its side surface, and to both end of it are fixedly attached, sandwiching two pieces of silicone packing 43, 44, a circular frame members 45, 46 (made of stainless steal) with bolts 48, 50.

FIG. 8 show a schematic view illustrating the apparatus being used to regenerate the edible oil. The nozzle 40 is immersed in the edible oil contained in an oil vessel 53. To the nozzle is pressure fed the activated air from the apparatus body 18 through the tubing 30 and the air spews, from the number of small holes in the cylindrical body forming the nozzle 42, into the edible oil 55, contacting it in the form of fine bubbles and reduces it.

### Test Example 1

### Regeneration of Waste Oils and Evaluation (Sensory Test)

Using the apparatus of the above example, waste oil was treated for regeneration, and the oil thus prepared was examined by a sensory evaluation method by humans. <Test materials and regeneration treatment>Three different waste oils listed in Table 1 were collected, which had been used in preparing fried foods and deteriorated up to the level at which they were to be discarded, and their acid values were determined. For this determination, a commercially available testing paper strips for acid value evaluation (3M High Sensitive Shortening Monitor, Sumitomo 3M) were used.

TABLE 1

| | Type and history | Acid value |
|---|---|---|
| Waste oil 1 | Refined oil used in preparing deep-fried foods | 4 |
| Waste oil 2 | Salad oil used in preparing pork cutlet | 5 |
| Waste oil 3 | Salad oil used in preparing various fried foods | 3.5 |
| | in a western food restaurant | |

A couple of samples of 5 L each were taken from each of the waste oils cooled to room temperature and put in separate glass vessels. The nozzle 40 of an apparatus as described in the above example was immersed in one of each couple of oil samples, and the apparatus was started to run at room temperature. Fine bubbles formed at the nozzle 40 continued to spew from it, and the oil was continuously stirred thereby. The electric power supply frequency in the location where this test was conducted was 60 Hz, and therefore the pump 20 blew at the flow rate of 16.5 L/min (so was the rate at which the activated air spewed from the nozzle 40), this corresponded to the air volume of 990 L per hour. The other oil sample was left to stand at room temperature and employed as an untreated control. One hour later, the treatment was finished.

### <Smelling Test>

A 50-mL aliquot of each of the regeneration-treated oil and untreated control as described above was separately put in a beaker. These test samples was either warmed to 60° C. or left at room temperature. Multiple subjects shown in Table 2 were instructed to smell them and choose the one that smelled less between the regeneration-treated oil and untreated control prepared from the same waste oil. The test was conducted in such a manner that the subjects were blind to which the regeneration-treated oil was.

TABLE 2

| | | | Temperature of |
|---|---|---|---|
| | Subjects | Age | test sample |
| Waste oil 1 | 8 males | 58, 55, 35, 32, 30, 28, 25, | 60° C. |
| | | 22 | |
| Waste oil 2 | 7 males | 59, 58, 56, 52, 43, 34, 20 | Room |
| | | | temperature |
| Waste oil 3 | 6 males and | 58, 57, 36, 32, 28, 20, 53 | Room |
| | 1 female | | temperature |

The result of the test revealed that all the subjects chose the regeneration-treated oils as less smelling for all the waste oils 1 to 3.

### <Tasting Test>

Ten L each of the above waste oils 1 to 3 were regeneration-treated in the same manner as described above (except that the treatment was done for 2 hours), and fried foods were prepared (at 160 to 170° C.) using these oils as well as corresponding untreated control oils (“Tempura” with the oil group of waste oil 1, pork cutlet with the oil group of waste oil 2, western style fried food with the oil group of waste oil 3). The same subjects as the above were instructed to taste these foods and choose the one that tasted better between the foods prepared with the regeneration-treated oil and untreated control prepared from the same waste oil. The test was conducted in such a manner that the subjects were blind to with which the regeneration-treated oil has been used.

As a result, it was revealed that, with regard to the waste oils 1 and 3, all of the 8 and 7 subjects, respectively, chose the foods prepared with the regeneration-treated oils as better tasting, and that, with regard to the waste oil 2, 6 subjects except one chose the foods prepared with the regeneration-treated oil as better tasting.

### Test Example 2

### Regeneration of Waste Oils and Evaluation (Chemical Test)

### <Evaluation Based on Polar Compounds>

Ten L of waste oil was regeneration-treated with the apparatus described in Example 1 (for 1 hour and 30 minutes), then used to fry 4 shrimps, and further regeneration-treated (15 minutes+15 minutes). Polar compounds value was determined using Test 265 (Test, Germany) before and after each step. Polar compounds value is a figure which represents the amount of polar substances contained in given oil and used in European countries as an index for evaluating deterioration of oil, a value of about 25 being the border line to decide to discard the oil. The following table shows the results.

TABLE 3
Change in polar compounds value

| | Polar |
|---|---|
| Step | compounds value |
| Before regeneration treatment | 28.0 |
| After regeneration treatment for 1 hour and 30 minutes | 23.0 |
| After cooking 4 shrimps | 26.5 |
| After regeneration treatment for 15 minutes | 22.5 |
| After regeneration treatment for further 15 minutes | 19.5 |

As seen in the table, the polar compounds value, which was 28.0 before regeneration treatment, was found to have decreased to 23.0 after the regeneration treatment for 1 hour and 30 minutes, indicating that regeneration proceeded. Though the polar compounds value elevated once again to 26.5 after the oil was used for cooking 4 shrimps, it rapidly came down with time as the oil was further regeneration-treated, and reached as low as 19.5 after only 30 minutes of regeneration treatment. This remarkable effect in regeneration supports the effect of the regeneration treatment with the apparatus according to the present invention as found in the above sensory test.

### <Evaluation Based on Acid Values-1>

Fifteen L of waste oil whose acid value was 4.5 were regeneration-treated for 2 hours with the apparatus as described in the above example, and its acid value was measured thereafter. The measurement of acid value was done using 3M High Sensitive Shortening Monitor (Sumitomo 3M). As a result, it was confirmed that the acid value was reduced from 4.5 to 2.5 through the regeneration treatment with the apparatus described in the example.

### <Evaluation Based on Acid Values-2>

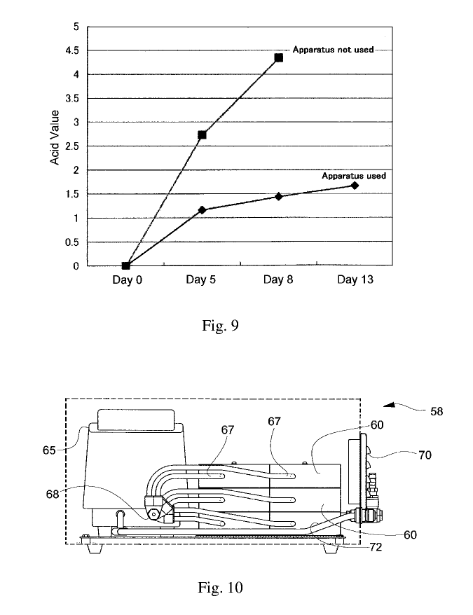

Two 32-L oil vessels were filled with fresh salad oil and used to prepare fried foods at the same temperature between them. After completion of the cooking operations for each day, the oil in one of the vessels was treated for 2 hours by aerating it with the air spewing at 16.5 L/min from the apparatus described in Example 1 of the present invention, and the other oil was left untreated. The changes in their acid values were measured and recorded for both oils up to day 13. The results are shown in FIG. 9. As evident from the figure, marked increase in acid value was noted for the oil which was not regeneration-treated, recording increases up to nearly 3 already on day 5, and up to 4.35 on day 8, whereas the increase in acid value was remarkably suppressed for the oil that was regeneration-treated with the apparatus according to the present invention, recording the acid value of 1.68 even on day 13. The results shows that though deterioration of the oil through oxidation proceeded each day during the cooking of fried foods, the oil was regenerated by the treatment following the cooking with the apparatus according to the present invention, and this being repeated day by day, the deterioration caused by oxidation of the oil was suppressed as a whole.

### Test Example 3

In a number of facilities where edible oil was used to prepare fried foods, a large-scale additional test was carried out during the period of from March to October, 2006, using the apparatus according to the present invention, for its effect in regeneration of edible oil, in a manner in which, after the business was over in each of their business days, the edible oil that had been used in preparing fried foods was put to the regeneration treatment with the apparatus. In the facilities, used oil was exchanged for fresh ones when the former exceeded the allowable acid value limit that was set by each of the facilities. Thus, the more rapidly did deterioration of the oil proceed, the more frequently the oil was exchanged, thereby ending in the more consumption of fresh oil. Therefore, the effect of regeneration of edible oil with the apparatus of the present invention can be roughly evaluated in the rate of reduction in consumption of edible oil, by comparing the consumption of edible oil per month after the introduction of the apparatus with that before its introduction. Table 4 shows commercial facilities which joined the test, the kind of oil used in preparing fried foods in each of the facilities, the volume of oil in the oil vessels employed, the allowable acid value limit, the mean consumption of oil per month before the introduction of the apparatus of the present invention (“previous consumption”), and the mean consumption of oil per month after the introduction of the apparatus of the present invention (“consumption after introduction of apparatus”). In the table, the “reduction rate” of consumption is defined as (previous consumption−consumption after introduction of apparatus)/previous consumption×100(%). An apparatus as described in Example 1 was used in each of the facilities Nos. 1 to 13 and run for 2 hours with the aeration rate adjusted to 16.5 L/min, while 6 air processor units arranged in parallel, each of which was as described in Example 1, were used in facilities Nos. 14 to 17, which were consuming a large volume of oil, and were run for 2 hours with the aeration rate adjusted to 16.5 L/min per unit.

TABLE 4

| | | | | | | Oil | | |
|---|---|---|---|---|---|---|---|---|
| | | | | | | consumption | | |
| | | | | | | (L/month) | | |
| | | | | Volume of | | | After | Reduction |
| | | | Type of | oil in oil | allowable acid | | introduction | rate |
| | Facilities | Location | oil | vessels (L) | value limit | Previous | of apparatus | (%) |
| 1 | Imperial IIotel Ltd. | Osaka | Salad | 18 | 3 | 153 | 90 | 41.2 |
| | | | oil | | | | | |
| 2 | Kyoto Hotel Co., | Kyoto | Salad | 18 | 3 | 144 | 81 | 43.8 |
| | Ltd. | | oil | | | | | |
| 3 | Andersen Bakeries | Tokyo | Salad | 54 | 2 | 720 | 430 | 40.3 |
| | Partners Co., Ltd. | | oil | | | | | |
| 4 | Sumitomo | Osaka | Salad | 18 | 3 | 126 | 54 | 57.1 |
| | Hospital, | | oil | | | | | |
| | Staff's dining room | | | | | | | |
| 5 | Honkekamadoya | Kobe | Salad | 18 | 3 | 216 | 108 | 50.0 |
| | Co., Ltd. | | oil | | | | | |
| 6 | Mycal Ist Co., Ltd. | Osaka | Salad | 27 | 3 | 405 | 108 | 73.3 |
| | | | oil | | | | | |
| 7 | B.I.C Co., Ltd. | Osaka | Salad | 18 | 3 | 108 | 65 | 59.7 |
| | | | oil | | | | | |
| 8 | Create M's Co., | Sendai | Salad | 18 | 3 | 720 | 468 | 35.0 |
| | Ltd. | | oil | | | | | |
| 9 | Ganko Food | Osaka | Salad | 32 | 3 | 272 | 108 | 60.3 |
| | Service | | oil with | | | | | |
| | Co., Ltd. | | lard | | | | | |
| 10 | Don Co., Ltd. | Tokyo | Salad | 18 | 3 | 252 | 126 | 50.0 |
| | | | oil | | | | | |
| 11 | Daiichi Foods Co., | Toyama | Lard | 100 | 2 | 1700 kg | 1200 kg | 29.4 |
| | Ltd. | | | | | | | |
| 12 | Nagasawa Foods | Kakogawa | Salad | 18 | 3 | 540 | 135 | 75.0 |
| | Co., Ltd. | | oil | | | | | |
| 13 | Handa Kiichi Co., | Osaka | Salad | 18 | 3 | 50 | 27 | 46.0 |
| | Ltd. | | oil | | | | | |
| 14 | Foods Japan Co., | Kyoto | Salad | 18 + 27 | 3 | 360 | 246 | 31.7 |
| | Ltd. | | oil | | | | | |

As shown in Table 4, monthly oil consumption dramatically reduced in all of the facilities after the application of the apparatus of the present invention, demonstrating that deterioration of the oil through oxidation was remarkably suppressed by the apparatus of the present invention. Meanwhile, development of bad smell of the oil employed was found suppressed, as well as improved draining of the oil from the food stuff (improved fluidity) in all the facilities.

### Example 2

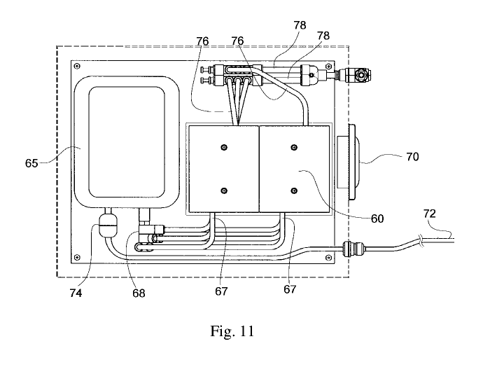

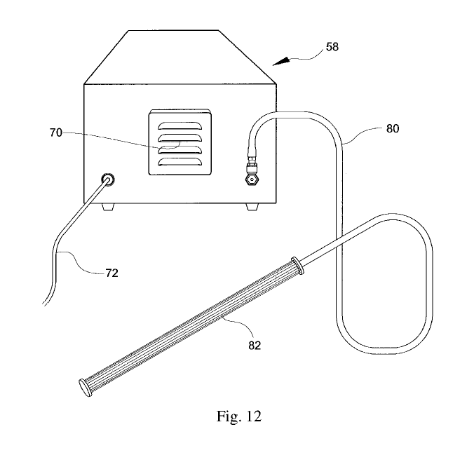

FIG. 10 illustrates a side view of the apparatus of another example of the apparatus of the present invention, wherein the cover of the apparatus 58 is depicted in phantom lines. In the figure, indicated by the numeral 60 is the same air processor unit as is described in Example 1, and 6 units are installed in total. Indicated by the numeral 65 is an electromagnetic pump for pressure feeding air to each of these air processor units through a corresponding one of the pipes 67, and the numeral 68 indicates a distribution tube serving to distribute the air from the pump 65 to each of the pipes. The pump 65 operates on the rated power of 100 V AC, and blow the air at a flow rate of 13.6 L/min per air processor unit where the electric power supply frequency is 50 Hz, and 16.5 L/min per unit where the frequency is 60 Hz. Indicated by the numeral 70 is an intake vent for taking the air into the apparatus body. FIG. 11 illustrates a plan view of the same apparatus, where the cover of the apparatus body is depicted in phantom lines. In FIG. 11, the numeral 72 indicates a power cable, 74 an AC coupler, 76 pipes for passing the air coming out of the air processor units, and 78 collecting pipes which collect the air from those pipes. FIG. 12 illustrates a schematic perspective view of the general appearance of the apparatus, in which the numeral 80 indicates a length of tubing made of silicone resin to pass through the air coming out from the air processor units, 82 a nozzle made of ceramic having a large number of small pores in its side surface. The apparatus of the present example is built simply by installing, in the apparatus body, multiple air processor units employed in Example 1 in parallel connection to the pump, instead of employing multiple apparatus of the Example 1, and it has increased processing capacity in proportion to the number of the air processor units employed.

### INDUSTRIAL APPLICABILITY

The present invention enables to reduce edible oil with raised oxidation degrees into oil with lowered oxidation degrees, and simultaneously, eliminate bad smell that has been caused by its deterioration, thereby improving the flavor of fried foods, and therefore enables to greatly extend the life of edible oil being used in preparing fried foods. Thus, it is useful in reducing the costs for cooking, and in cutting the gross production of waste oil.

1. An edible oil regenerating apparatus comprising:
an air processor unit comprising a first air flow path configured to have an inlet and an outlet and allow air to pass between magnets positioned in close vicinity with their opposite magnetic poles facing each other, and a second air flow path connected to the outlet of the first air flow path and provided with a far-infrared ray emitter member therein,
a pump for pressure feeding air to the inlet to the first flow path of the air processor unit,
a length of tubing which is connected to the outlet of the second air flow path of the air processor unit, and
one or more air spewing holes provided at the tip of the length of tubing.

2. The edible oil regenerating apparatus according to claim 1, wherein the magnetic flux density between the magnets is not less than 3400 [G].

3. The edible oil regenerating apparatus according to claim 1, wherein the ratio of the length along which the air passes through between the magnets to the distance between the magnets faced with each other is not less than 12.

4. The edible oil regenerating apparatus according to claim 1, wherein the distance between the magnets is 2 to 5 mm.

5. The edible oil regenerating apparatus according to claim 1, wherein the pump pressure feeds the air so that the inequality Bv≧5100 [Gm/sec] holds, wherein B [G] is the magnetic flux density between the magnets, and v [m/sec] is the velocity of the air passing through between the magnets.

6. The edible oil regenerating apparatus according to claim 1, wherein L and B are selected so that L and B let inequality LB≧200 [Gm] hold, wherein L [m] is the length along which any portion of the air passes through between the magnets.

7. The edible oil regenerating apparatus according to claim 1, wherein the magnetic flux density between the magnets is not less than 3400 [G] and the pump pressure feeds the air so that velocity v of the air passing through between the magnets is not less than 1.5 [m/sec].

8. The edible oil regenerating apparatus according to claim 1, wherein the far-infrared ray emitter member is a sheet carrying fine powder of charcoal disposed along the longitudinal direction of the second air flow path.

9. The edible oil regenerating apparatus according to claim 1, wherein the air passing through the second air flow path flows for at least 0.3 second along the far-infrared ray emitter member.

10. The edible oil regenerating apparatus according to claim 1, wherein the tubing is made of Teflon™ or silicone resin, and the air spewing holes are one or more small holes provided in a nozzle made of metal or ceramic provided at the tip of the length of tubing.

11. A method for regenerating edible oil comprising:
passing air through a space between magnets where the magnetic flux density B is not less than 3400 [G] at a velocity v [m/sec] that lets the inequality Bv≧5000 [Gm/sec] hold,
leading the air that has thus passed to a flow path provided with a far-infrared ray emitter member therein and taking out the air therethrough, and
bringing the air into contact with deteriorated edible oil to be treated.

12. The method for regenerating edible oil according to claim 11, wherein L and the magnetic flux density B [G] between magnets are selected so that L and B let inequality LB≧200 [Gm] hold, wherein L [m] is the length along which any portion of the air passes through between the magnets.

13. The method for regenerating edible oil according to claim 11, wherein the magnetic flux density B between the magnets is not less than 3400 [G] and a pump pressure feeds the air so that velocity v [m/sec] of the air passing through between the magnets is not less than 1.5 [m/sec].

14. The method for regenerating edible oil according to claim 11, wherein the far-infrared ray emitter member is a sheet carrying fine powder of charcoal.

15. The method for regenerating edible oil according to claim 11, wherein the ratio of the length along which the air passes through between the magnets to the distance between the magnets is not less than 12.

16. The method for regenerating edible oil according to claim 11, wherein the distance between the magnets is 2 to 5 mm.
